(19) United States
(12) Patent Application Publication
(10) Pub. No.: US 2006/0007053 A1
(43) Pub. Date: Jan. 12, 2006

(54) Multi-panel liquid crystal display and method for driving same

(76) Inventors: Kuo-Chih Lee, Sinhua Township (TW); Hui-Kai Chou, Taipei City (TW); Ting-Shih Hsu, Taoyuan City (TW)

Correspondence Address: RABIN & Berdo, PC, 1101 14TH STREET, NW, SUITE 500, WASHINGTON, DC, 20005, US

(21) Appl. No.: 11/033,537

(22) Filed: Jan. 12, 2005

(30) Foreign Application Priority Data
Jun. 10, 2004 (TW) 93116738

(51) Int. Cl. G09G 5/00

(52) U.S. Cl. 345/1.3; 349/87

(57) ABSTRACT

A multi-panel liquid crystal display and a method for driving same. The multi-panel LCD includes an interface circuit and a LCD module. The interface circuit is used for receiving a first image data and outputting a second image data. The LCD module includes a timing controller, a first panel module and a second panel module. The timing controller receives the second image data and outputting a third image data and a fourth image data responsive to the second image data. The first panel module and the second panel module respectively display a first frame and a second frame responsive to the third and fourth image data.

This application claims the benefit of Taiwan application Serial No. 93116738, filed Jun. 10, 2004, the subject matter of which is incorporated herein by reference.

### BACKGROUND OF THE INVENTION

1. Field of the Invention

The invention relates in general to a liquid crystal display, and more particularly to a multi-panel liquid crystal display and a method for driving the same.

2. Description of the Related Art

Because liquid crystal displays (LCDs) have the advantages of thin, light, and low electromagnetic radiation, it is gradually and widely used recently. FIG. 1 is an architecture diagram showing a conventional LCD. The LCD 100 includes an interface circuit 101 and a LCD module 102. The interface circuit 101 receives an external image data, such as that outputted from a personal computer, converts the image data into a digital image data, and outputs the digital image data. The LCD module 102 further displays a frame according to the digital image data.

The external image data may be, for example, a digital DVI data, an analog S video data, a composite video data, a D-sub video data, or the like. The interface circuit 101 includes a scaler IC (not shown) for adjusting the magnitude of the external image data and then outputting the digital image data.

The LCD module 102 includes a control circuit 110 and a panel module 120. The control circuit 110 drives the panel module 120 to display the frame according to the digital image data. The control circuit 110 includes a timing controller 112, a color corrector 114, and a DC-DC power converter 116. The panel module 120 includes a data driver 122, a scan driver 124 and a liquid crystal panel 126.

The timing controller 112 receives the digital image data and then outputs the first image data to the data driver 122. The color corrector 114 outputs color correction parameters, which include, for example, multiple Gamma voltages, to the data driver 122 according to the property of the liquid crystal panel 126. The DC-DC power converter 116 is for outputting a DC power as the power for the panel module 120.

However, the typical LCD can only display one frame. Multiple LCDs have to be purchased if multiple frames are to be displayed at the same time, and the cost is too high.

### SUMMARY OF THE INVENTION

It is therefore objects of the invention to provide a multi-panel liquid crystal display for displaying the same frame or different frames and a method for driving the same.

The invention achieves the above-identified object by providing a multi-panel liquid crystal display (LCD). The LCD includes an interface circuit and a LCD module. The interface circuit is used for receiving a first image data and outputting a second image data. The LCD module includes a control circuit, a first panel module and a second panel module. The control circuit includes a timing controller, a color corrector and a DC-DC power converter. The timing controller is for receiving the second image data and outputting a third image data and a fourth image data according to the second image data. The color corrector is for outputting a first color correction parameter and a second color correction parameter. The DC-DC power converter is for outputting a first DC power and a second DC power. The first panel module is operable under the first DC power, and displays a first frame according to the first color correction parameter and the third image data. The second panel module is operable under the second DC power, and displays a second frame according to the second color correction parameter and the fourth image data.

The invention achieves another object by providing a method for driving a multi-panel liquid crystal display (LCD). The method first receives a second image data and outputting a third image data and a fourth image data responsive to the second image data. Then, the method outputs a first color correction parameter and a second color correction parameter. The method also outputs a first DC power and a second DC power. Then, the method displays a first frame responsive to the first color correction parameter and the third image data on a first panel module of the LCD under the first DC power, and displays a second frame responsive to the second color correction parameter and the fourth image data on a second panel module of the LCD under the second DC power.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is an architecture diagram showing a conventional LCD.

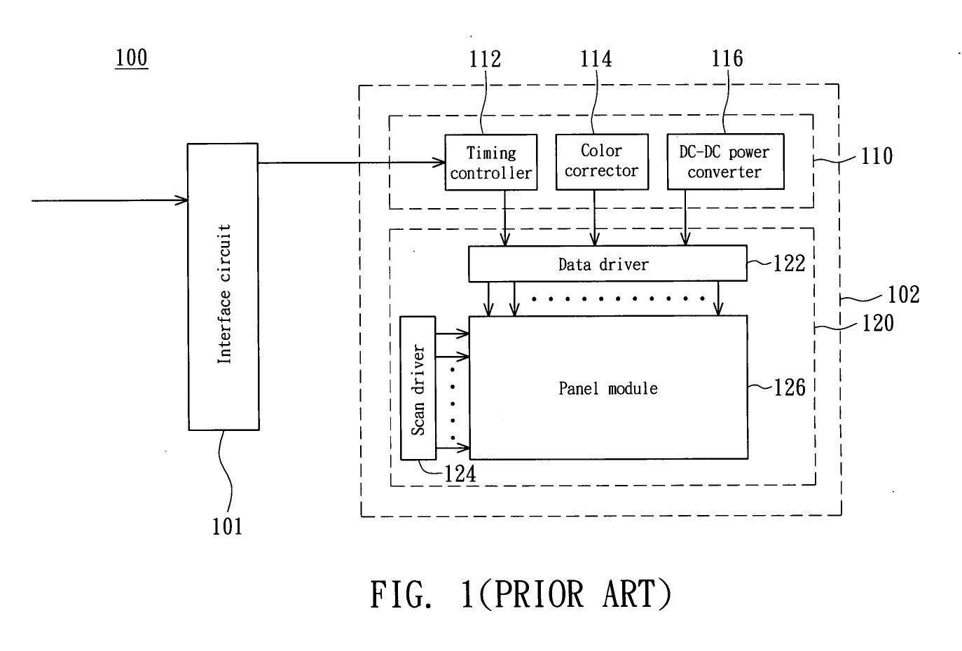

FIG. 2 is an architecture diagram showing a multi-panel LCD according to a preferred embodiment of the invention.

FIG. 3 is an architecture diagram showing a multi-panel LCD according to another preferred embodiment of the invention.

FIG. 4 is a flow chart of a method for driving a multi-panel LCD.

### DETAILED DESCRIPTION OF THE INVENTION

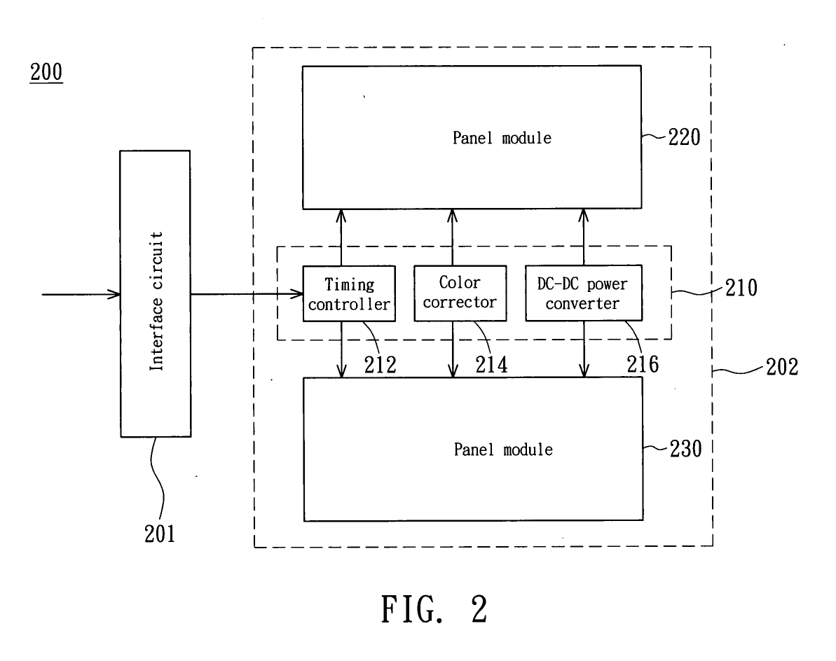

FIG. 2 is an architecture diagram showing a multi-panel LCD according to a preferred embodiment of the invention. Referring to FIG. 2, the LCD 200 includes an interface circuit 201 and a LCD module 202. The interface circuit 201 receives a first image data, outputs a second image data to the LCD module 202, and thus displays a first frame and a second frame.

The LCD module 202 includes a control circuit 210, and panel modules 220 and 230. The control circuit 210 drives the panel modules 220 and 230 to display the first frame and the second frame, respectively, according to the second image data. The control circuit 210 includes a timing controller 212, a color correction unit 214 and a DC-DC power converter 216. Each of the panel modules 220 and 230, such as the conventional panel module, have a data driver, a scan driver and a liquid crystal panel, which are not illustrated in the drawing of this embodiment.

The timing controller 212 receives the second image data and outputs a third image data and a fourth image data according to the second image data. The color corrector 214 outputs a first color correction parameter and a second color correction parameter according to the properties of the panel modules 220 and 230. The first and second color correction parameters may, for example, have multiple Gamma voltages. The DC-DC power converter 216 outputs a first DC power and a second DC power as the powers for the panel modules 220 and 230. The panel module 220 is operable under the first DC power and displays the first frame according to the first color correction parameter and the third image data. The panel module 230 is operable under the second DC power and displays the second frame according to the second and fourth color correction parameters.

In this embodiment, the third and fourth image data outputted from the timing controller 212 are the same such that the first and second frames displayed by the panel modules 220 and 230 are the same. In addition, the first and second color correction parameters are the same, and the first and second DC powers are also the same. Because the LCD of this embodiment can control the displays of two panel modules using only one control circuit, the manufacturing cost thereof may be reduced. In addition, this embodiment is not limited to the usage of two panel modules. It is also possible to use more than two panel modules.

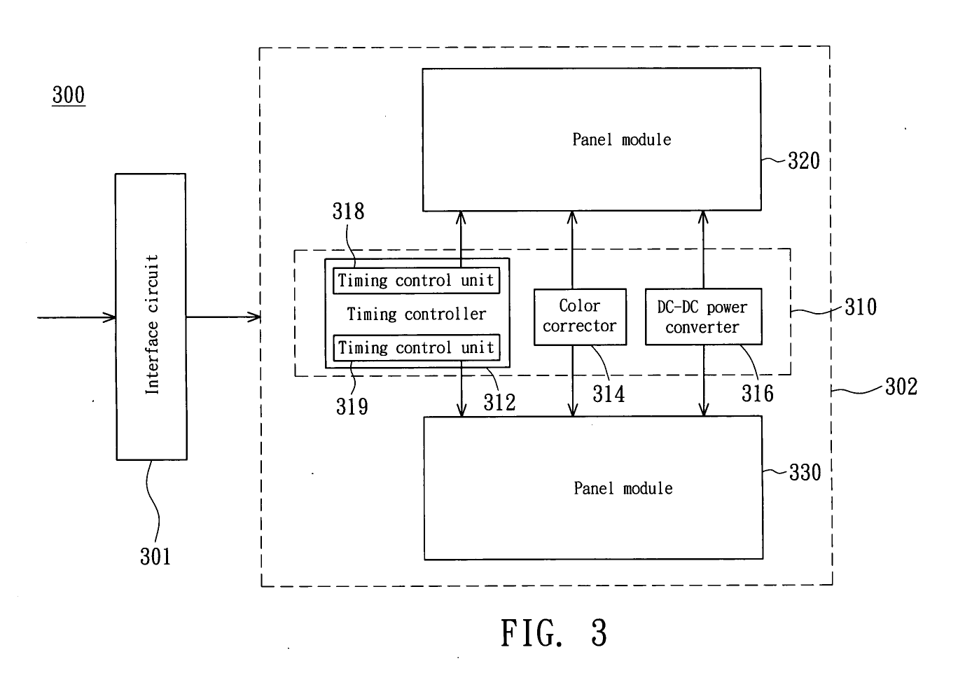

FIG. 3 is an architecture diagram showing a multi-panel LCD according to another preferred embodiment of the invention. Referring to FIG. 3, the LCD 300 includes an interface circuit 301 and a LCD module 302. The interface circuit 301 is for receiving a first image data and outputting a second image data to the LCD module 302 according to the first image data so as to display a first frame and a second frame.

The LCD module 302 includes a control circuit 310 and panel modules 320 and 330. The control circuit 310 drives the panel modules 320 and 330 to display the first frame and the second frame, respectively, according to the second image data. The control circuit 310 includes a timing controller 312, a color corrector 314 and a DC-DC power converter 316. Each of the panel modules 320 and 330, such as the conventional panel module, has a data driver, a scan driver and a liquid crystal panel, which are not illustrated in the drawing of this embodiment.

The timing controller 312 receives the second image data and outputs a third image data and a fourth image data responsive to the second image data. The color corrector 314 outputs a first color correction parameter and a second color correction parameter according to the properties of the panel modules 320 and 330. The first and second color correction parameters may, for example, have multiple Gamma voltages. The DC-DC power converter 316 outputs a first DC power and a second DC power as the powers for the panel modules 320 and 330. The panel module 320 is operable under the first DC power and displays the first frame responsive to the first color correction parameter and the third image data. The panel module 330 is operable under the second DC power and displays the second frame responsive to the second and fourth color correction parameters.

In this embodiment, the timing controller 312 further includes a timing control unit 318 and a timing control unit 319. The timing control unit 318 outputs the third image data responsive to the second image data so as to control the panel module 320 correspondingly. The timing control unit 319 outputs the fourth image data responsive to the second image data so as to control the panel module 330 correspondingly. The second image data includes two different frame data such that the third image data and the fourth image data are different, and the first and second frames are therefore different. The first and second color correction parameters are the same, and the first and second DC powers are also the same. This embodiment enables the two panel modules to display different frames using one control circuit, so the cost of the LCD may be reduced and the LCD may be used conveniently. In addition, the embodiment is not limited to the usage of two panel modules. It is also possible to use more than two panel modules.

In the multi-panel LCD according to each embodiment of the invention, the same control circuit is used to correspondingly control multiple panel modules to display the same frame or different frames. So, the production cost may be reduced and the LCD may be miniaturized.

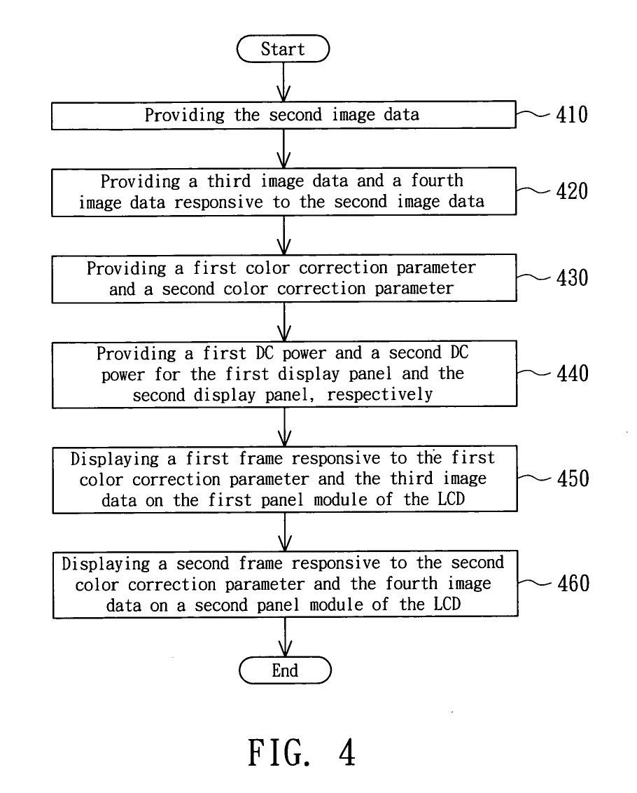

FIG. 4 is a flow chart of a method for driving a multi-panel LCD, having a first panel module, a second panel module and a timing controller, according to a preferred embodiment of the invention. First of all, the second image data is provided to the timing controller in step 410 and then the timing controller outputs the third image data and the fourth image data, responsive to the second image data, in step 420. Next, a first color correction parameter and a second color correction parameter are provided in step 430 and a first DC power and a second DC power for the first display panel and the second display panel, respectively, are provided in step 440. Then, step 450 is performed to display a first frame responsive to the first color correction parameter and the third image data on a first panel module under the first DC power. At the same time, step 460 is performed to display a second frame responsive to the second color correction parameter and the fourth image data on a second panel module under the second DC power. The first and second DC powers are the same

The above-mentioned driving method can be applied to the LCD module 202 or LCD module 302. While the method is applied to the LCD 202, the first and second color correction parameters, the third and fourth image data are the same such that the frames displayed on the first panel module and the second module are substantially the same.

While the method is applied to the LCD 302, the first and second color correction parameters, the third and fourth image data are not the same such that the frames displayed on the first panel module and the second module are substantially different.

While the invention has been described by way of example and in terms of preferred embodiments, it is to be understood that the invention is not limited thereto. Rather, it is intended to cover various modifications and similar arrangements and procedures, and the scope of the appended claims therefore should be accorded the broadest interpretation so as to encompass all such modifications and similar arrangements and procedures.

What is claimed is:

1. A multi-panel liquid crystal display (LCD), comprising:
an interface circuit for receiving a first image data and outputting a second image data; and
a LCD module, which comprises:
a timing controller for receiving the second image data and outputting a third image data and a fourth image data responsive to the second image data;
a color corrector for outputting a first color correction parameter and a second color correction parameter;
a DC-DC power converter for outputting a first DC power and a second DC power;
a first panel module operable under the first DC power to display a first frame responsive to the first color correction parameter and the third image data; and
a second panel module operable under the second DC power to display a second frame responsive to the second color correction parameter and the fourth image data.

2. The LCD according to claim 1, wherein the third and fourth image data are the same such that the first and second frames are substantially the same.

3. The LCD according to claim 1, wherein the first and second color correction parameters are the same.

4. The LCD according to claim 1, wherein the first and second DC powers are the same.

5. The LCD according to claim 1, wherein the third and fourth image data are different such that the first and second frames are different.

6. The LCD according to claim 5, wherein the timing controller includes a first timing control unit and a second timing control unit for respectively outputting the third and fourth image data responsive to the second image data.

7. A method for driving a multi-panel liquid crystal display (LCD) having a first panel module and a second panel module, comprising:
providing a first image data;
providing a second image data and a third image data responsive to the first image data;
providing a first color correction parameter and a second color correction parameter;
providing a first DC power and a second DC power for the first display panel and the second display panel, respectively;
displaying a first frame responsive to the first color correction parameter and the second image data on a first panel module of the LCD under the first DC power; and
displaying a second frame responsive to the second color correction parameter and the third image data on a second panel module of the LCD under the second DC power.

8. The method according to claim 7, wherein the second and third image data are the same such that the first and second frames are substantially the same.

9. The method according to claim 7, wherein the first and second color correction parameters are the same.

10. The method according to claim 7, wherein the first and second DC powers are the same.

11. The method according to claim 7, wherein the second and third image data are different such that the first and second frames are different.
